(19) United States
(12) Patent Application Publication
(10) Pub. No.: US 2003/0029700 A1
(43) Pub. Date: Feb. 13, 2003

(54) Indexing conveyor with operable part retaining mechanism

(76) Inventor: Jack E. Miller, Clinton Twp., MI (US)

Correspondence Address: Andrew R. Basile, Young & Basile, P.C., Suite 624, 3001 West Big Beaver Road, Troy, MI, 48084, US

(21) Appl. No.: 09/974,213

(22) Filed: Oct. 9, 2001

Related U.S. Application Data
(60) Provisional application No. 60/310,598, filed on Aug. 7, 2001.

(51) Int. Cl. B65G 29/00

(52) U.S. Cl. 198/803.7

(57) ABSTRACT

An apparatus for transporting parts along a fixed path. At least one cradle is provided for receiving at least one part to be transported. An endless conveyor extends around first and second rollers disposed at first and second ends for movement of the conveyor along the fixed path. A mechanism retains each part to be transported with respect to a corresponding cradle while moving along at least a portion of the fixed path. The retaining mechanism can be actuated between a part-retaining position and a part-releasing position by operable engagement of a cam follower with a cam surface extending along either the entire fixed path, or any one or more parts of the path as required for the particular application. A spring can be provided for biasing the retaining mechanism toward either the open or the closed position as required.

### FIELD OF THE INVENTION

The present invention relates to an indexing conveyor capable of being driven in either direction and including part-engaging gripper members for holding a part, if present, in relation to the part-supporting cradles of the conveyor.

### BACKGROUND OF THE INVENTION

Various conveyor systems with gripping elements have been proposed. One such conveyor includes a plurality of couplings, where each coupling includes an outer cup-shaped member which can retain the longitudinal end of a workpiece with radially inwardly movable fingers or an internal chuck structure. Other conveyors have been proposed that include clamping devices or grips for engaging and handling newspapers or magazines. However, none of these devices are suitable for retaining a part with respect to a cradle supporting opposite longitudinal ends of the part as the part moves along the conveyor path of travel.

### SUMMARY OF THE INVENTION

An apparatus according to the present invention for transporting parts includes at least one cradle for receiving a part to be supported. An endless loop conveyor extends around first and second rollers disposed at first and second ends. The conveyor supports each cradle for transport along a fixed path of travel. Means is provided for selectively and operably engaging each individual part. The engaging means can retain the corresponding part with respect to the corresponding cradle at or between workstations. By way of example and not limitation, the engaging means can retain the part with respect to the cradle when in an upright position adjacent one end of the endless loop conveyor in order to carry the part through at least a portion of the inverse orientation and/or to the opposite end of the conveyor, where the cradle and carried workpiece can be returned to an upright orientation.

The part grippers can be normally biased to either an opened position or a closed position. Preferably, the part grippers are located between each pair of spaced part-supporting stanchions defining the cradle. A clamp-actuating roller can be positioned on the opposite side of the conveyor from the clamp member and can engage with a guide slot or along a cam surface to drive the workpiece clamp member from the biased position to the unbiased position. By way of example and not limitation, if the part grippers are normally biased to a closed position, the rollers engagement with a guide slot or cam surface can drive the workpiece clamp member from the closed or engaged position to an open or disengaged position. Movement to the disengaged position would typically occur when the part-supporting stanchions are located at a workstation requiring release of the workpiece. If the clamp is normally spring biased into the open position, the roller actuator can engage with a guide slot or cam surface to close the clamp member to retain the workpiece on the stanchions as the workpiece moves along the conveyor path. The cam surface or guide slot can extend along the entire path of the conveyor, or can be intermittent for releasing and/or for anchoring the part to the stanchions as required along the workpiece path. Various configurations of the clamp or grippers are included in the present invention.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a side elevational view of the apparatus for transporting parts along a fixed path according to the present invention;

FIG. 2 is an end elevational view of the apparatus illustrated in FIG. 1;

FIG. 3 is a detailed, partial end view of the stanchions defining the part-supporting cradle and the gripper or clamping members according to the present invention;

FIG. 4 is a detailed, partial side elevational view of one end of the apparatus according to the present invention showing one possible configuration for operably engaging a workpiece with respect to the stanchions defining the cradle;

FIG. 5 is a detailed side elevational view of means for retaining each part to be transported with respect to a corresponding cradle illustrating transition from a closed position to an opened position;

FIG. 6 is a side elevational view of an alternative retaining means with a continuous cam surface between the closed position and the opened position;

FIG. 7 is a side elevational view of retaining means having a discontinuous cam surface and a linkage assembly for actuating the opposing arms with respect to one another between a normal open position and a cam-follower-actuated closed position;

FIG. 8 is a side elevational view of retaining means having a different linkage configuration between the actuator and the opposed pivoting arms movable between a spring-biased opened position and a cam-follower-actuated closed position;

FIG. 9 is a side elevational view of retaining means having another linkage configuration between the actuator and the opposed pivoting arms moveable between a spring-biased closed position and a cam-follower-actuated open position;

FIG. 10 is a side elevational view of retaining means having a rotational linkage configuration between the actuator and the opposed retaining arm moveable between a spring-biased closed position and a cam-follower-actuated open position; and

FIG. 11 is a simplified exploded perspective view of retaining means having a laterally shifting linkage configuration between the actuator and the retaining arms moveable between a retaining position and a releasing position.

### DETAILED DESCRIPTION OF THE PREFERRED AND ALTERNATIVE EMBODIMENTS

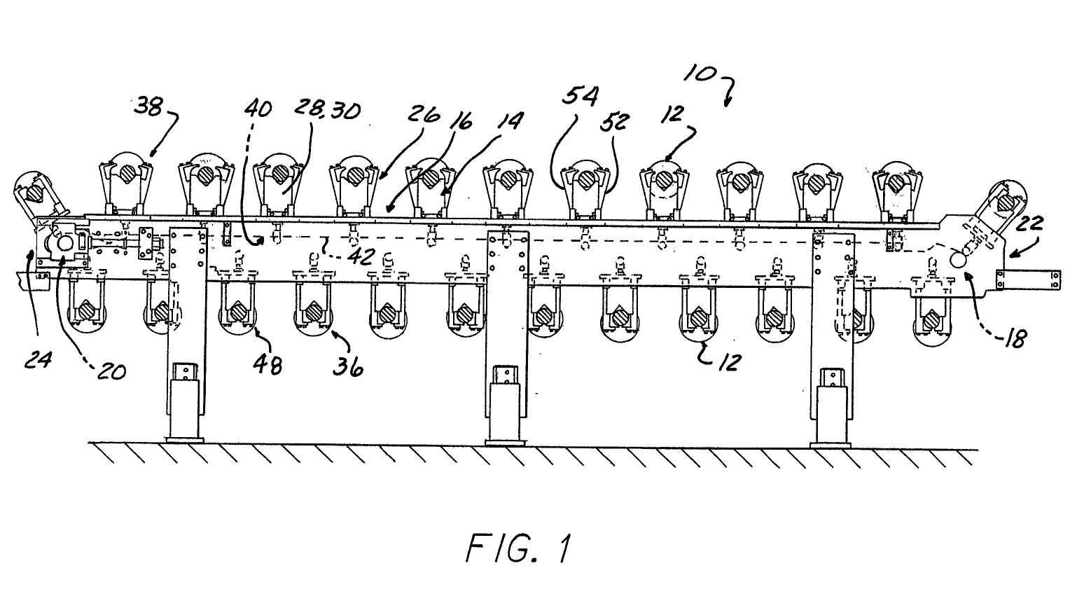

Referring now to FIGS. 1-3, an apparatus 10 is illustrated for transporting workpieces or parts 12. At least one cradle 14 is provided for receiving at least one workpiece or part 12 to be transported. An endless loop conveyor 16 extends around first and second rollers 18, 20 positioned at first and second ends 22, 24 respectively. The endless loop conveyor 16 supports each cradle 14 for movement along a fixed path of travel. Means 26 is provided for retaining each workpiece or part 12 to be transported with respect to a corresponding cradle 14 while moving along at least a portion of the fixed path of travel. The conveyor 16 can extend through one or more workstations where various processing operations are performed with respect to the workpiece or part 12 being transported by the conveyor 16. The conveyor 16 can also extend through a loading workstation and/or unloading workstation. The endless loop conveyor 16 can move each cradle 14 in at least one direction of travel, or can be powered by a reversible motor to move in either a clockwise direction or counter clockwise direction around the first and second rollers 18, 20 as illustrated in FIG. 1. By way of example and not limitation, FIG. 1 will be discussed with reference to counter clockwise movement of the conveyor 16 around the first and second rollers 18, 20. The endless loop conveyor 16 moves each cradle 14 between the first end 18 and the second end 20 in an upright orientation along one portion of the fixed path of travel and in an inverted orientation along another portion of the fixed path of travel.

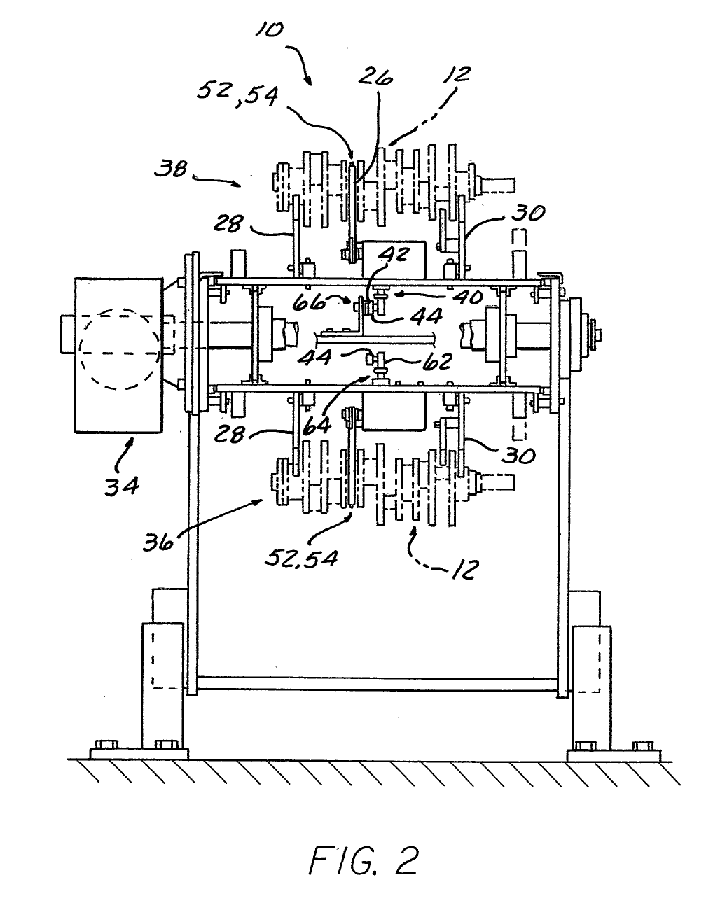

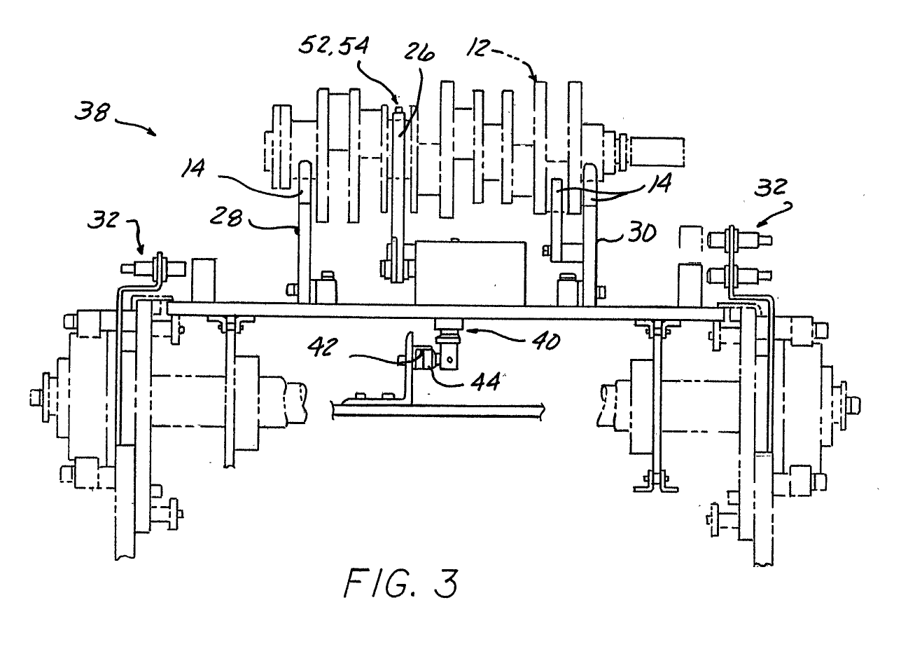

As best seen in FIGS. 2 and 3, each cradle 14 can include at least two spaced stanchions 28, 30 engagable with spaced longitudinal portions of the workpiece or part 12 to be transported. The retaining means 26 is preferably between the at least two spaced stanchions 28, 30 of each cradle 14. At least one sensor 32 can be provided at one or more workstations to signal the presence of a cradle 14, sometimes referred to in the industry as a part nest or pallet assembly, at the particular workstation as best seen in FIG. 3. A motor 34, such as a unidirectional motor or reversible motor, can be provided connected to one of the first and second rollers 18, 20 for driving the endless conveyor 16 along the fixed path of travel as best seen in FIG. 2.

Referring again to FIGS. 1-3, the retaining means 26 is movable between a closed position 36 for retaining each workpiece or part 12 to be transported with respect to the corresponding cradle 14, and an opened position 38 allowing removal of each workpiece or part 12 to be transported from the corresponding cradle 14. The conveyor 16 illustrated in FIG. 1 depicts the retaining means 26 being in the opened position 38 when in an upright orientation along one portion of the fixed path of travel, such as in an upright orientation, while being in the closed position 36 along another portion of the fixed path of travel, such as in an inverted orientation. However, it should be recognized that the retaining means 26 can be actuated between the closed position 36 and the opened position 38 in other controlled sequences. By way of example and not limitation, the retaining means 26 can be in the closed position 36 while traveling between workstations, and moved to the opened position 38 while at a workstation location.

Means 40 is provided for actuating the retaining means 26 between the opened position 38 and the closed position 36. The actuating means 40 can be provided to open and close the retaining means in any desired sequence for the particular application, or processing to be performed for the particular workpiece or part 12 to be transported along the endless loop conveyor 16. As best seen in FIGS. 2 and 3, the actuating means 40 can include a cam surface 42 extending along at least a portion of the fixed path of travel of the conveyor 16. The cam surface 42 can be a substantially continuous cam surface extending along the entire fixed path of travel of the conveyor 16, or can be a discontinuous cam surface for moving the retaining means 26 from one of the closed position 36 or the opened position 38 to the other position, and/or to maintain the retaining means 26 in the other position along a portion of the fixed path until the point where the cam surface 42 is discontinued. A cam follower 44 is operably connected to the retaining means 26. The cam follower 44 is engagable with the cam surface 42 for moving the retaining means 26 between the opened and closed positions 38, 36 respectively in response to the cam follower 44 moving along the cam surface 42.

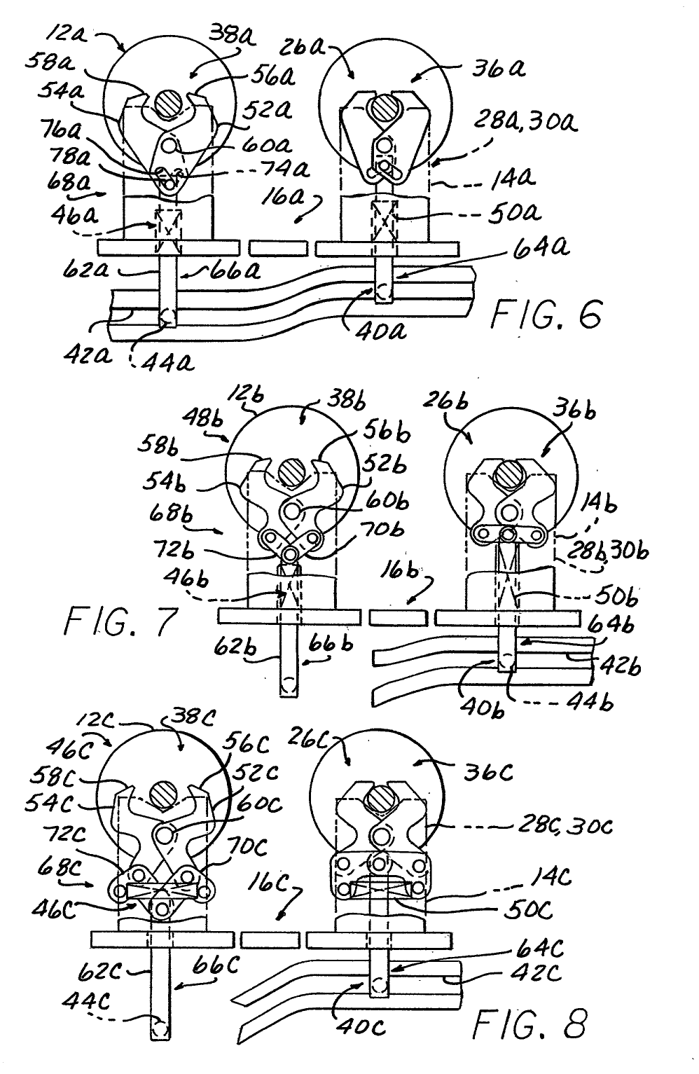

Biasing means 46 can be provided for urging the retaining means 26 toward one of the opened position 38 and the closed position 36, hereinafter defined as a biased position 48. The interaction of the cam follower 44 operably engaging with the cam surface 42 can move the retaining means 26 to an opposite position from the biased position 48 against the urging of the biasing means 46. As previously described, track 42 is not required to extend along the entire path of travel of the conveyor to hold the retaining means in the biased position if biasing means 46 is provided and loaded in the proper direction for the default position desired. By way of example and not limitation, the conveyor 16 illustrated in FIGS. 1-3 includes retaining means 26 with biasing means 46, such as a spring 50, for normally urging the retaining means 26 toward the closed position 36. The retaining means 26 is maintained in the closed position 36 until the cam follower 44 engages with the cam surface 42 to move the actuating means 40 from the closed position 36 to the opened position 38 in response to the cam follower 44 moving along the cam surface 42 as best seen in FIG. 5. Alternatively, the biasing means 46, such as spring 50, can bias the actuating means toward the opened position 38, while the cam follower moves the actuating means 40 from the opened position to the closed position in response to the cam follower moving along the cam surface similar to that shown in FIG. 7 or 8. The transition between the opened and closed positions can occur along a straight portion of the fixed path, and/or can occur along a curved portion of the fixed path. The retaining means 26 can be opened and closed one or more times along the fixed path as required for a particular application. If a normally biased position is not desired, the cam surface 42 can extend substantially continuously along the entire fixed path for moving the retaining means 26 between the opened and closed position one or more times as required for the particular application similar to that illustrated in FIG. 6.

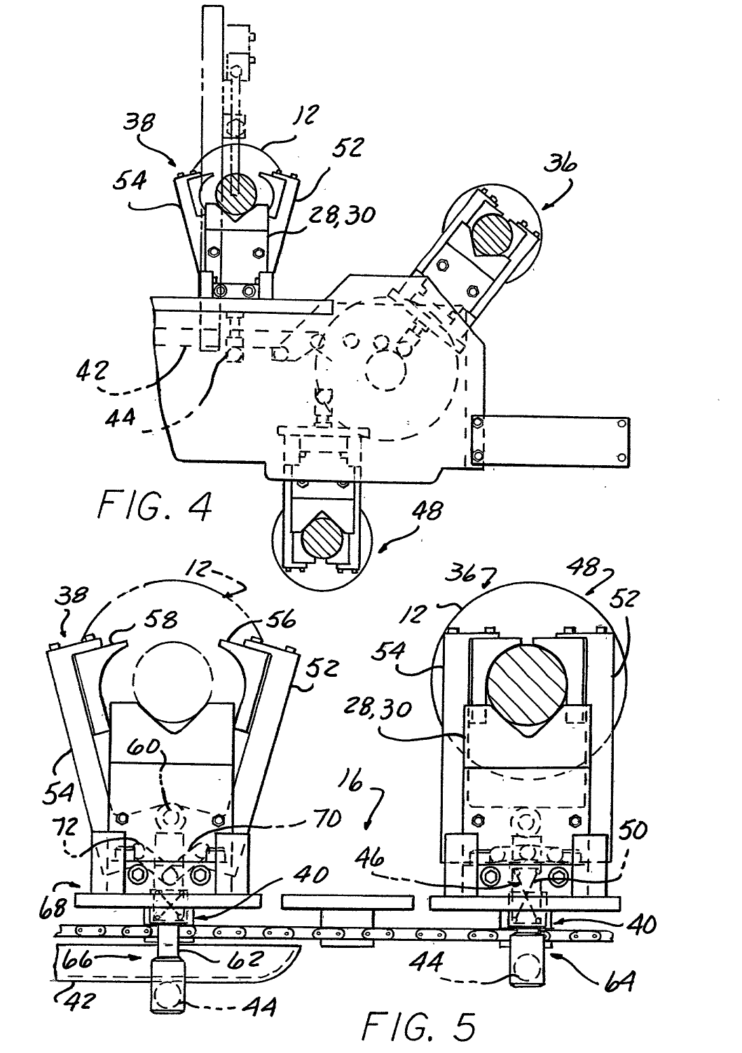

Referring now to FIGS. 4 and 5, the retaining means 26 can include at least one pivotable gripper, clamp, or arm 52, 54 associated with each cradle 14. Preferably, a pair of pivotable arms 52, 54 is provided having corresponding part-retaining ends 56, 58 movable toward and away from one another in response to pivoting movement of the respective arms 52, 54 with respect to one another. In the preferred configuration, the pair of pivotable arms 52, 54 have a common pivot axis 60.

The actuating means 40 can include an actuator 62 moveable between first and second positions corresponding to a part-retaining position 64 illustrated in the right hand portion of FIG. 5, and a part-releasing position 66 illustrated in the left hand portion of FIG. 5. The actuating means 40 can also include means 68 for connecting the actuator 62 to the corresponding pair of pivotable arms 52, 54 for driving the arms 52, 54 in pivoting movement in response to movement of the actuator 62 between the first and second positions. The connecting means 68 can include at least one pivotable link 70, 72 connected between each actuator 62 and each pivotable arm 52, 54 of the corresponding pair of pivotable arms 52, 54 for moving the arms 52, 54 in pivoting movement with respect to one another in response to movement of the actuator between the first and second positions. The cam surface 42 can extend along at least a portion of the fixed path of travel for the endless loop conveyor 16. The cam follower 44 is connected to each actuator 62 and is engagable with the cam surface 42 for moving the actuator 62 between the first and second positions in response to the cam follower 44 moving along the cam surface 42 as best seen in FIG. 5.

Referring now to FIG. 6, an alternative configuration for the retaining means 26a is illustrated. The retaining means 26a can include at least one pivotable gripper, clamp or arm 52a, 54a for retaining the workpiece or part 12a with respect to the corresponding cradle 14a while moving along at least a portion of the fixed path defined by the endless loop conveyor 16a. The retaining means 26a can include a pair of pivotable arms 52a, 54a where each pair of pivotable arms 52a, 54a have pair-retaining ends 56a, 58a respectively movable toward and away from one another in response to pivoting movement of the arms 52a, 54a with respect to one another. Preferably, the pair of pivotable arms 52a, 54a have a common pivot axis 60a. An actuator 62a is movable between a first or part-retaining position 64a illustrated to the right hand side of FIG. 6 and a second or part-releasing position 66a illustrated on the left hand side of FIG. 6. Means 68a for connecting the actuator 62a to the corresponding pair of pivotable arms 52a, 54a is provided. The connecting means 68a drives the arms 52a, 54a in pivoting movement in response to movement of the actuator 62a between the first and second positions 64a, 66a as the endless loop conveyor 16a moves toward the right or toward the left depending on the direction of travel. The connecting means 68a can include a cam surface 74a, 76a formed in each pivotable arm 52a, 54a of the corresponding pair. A cam follower 78a is connected to the actuator 62a and engagable with each of the cam surfaces 74a, 76a of the corresponding pivotable arms 52a, 54a for moving the arms in pivoting movement with respect to one another in response to movement of the actuator 62a between the first and second positions 64a, 66a. Biasing means 46a can be provided for biasing the pivotable arms 52a, 54a toward one of the first and second positions 64a, 66a if required for a particular application. The biasing means 46a can include a spring 50a. The cam surface 42a can extend along all or any part of the fixed path defined by the endless loop conveyor 16a.

Referring now to FIG. 7, an alternative configuration for the retaining means 26b is illustrated. At least one cradle 14b is provided for receiving at least one part or workpiece 12b to be transported. An endless loop conveyor 16b extends along a fixed path and supports each cradle 14b. The retaining means 26b holds each workpiece or part 12b to be transported with respect to a corresponding cradle 14b while moving along at least a portion of the fixed path defined by the endless loop conveyor 16b. The retaining means 26b can include at least one gripper, clamp or arm 52b, 54b, and preferably a pair of pivotable arms 52b, 54b associated with each cradle 14b. Each pair of pivotable arms 52b, 54b has part-retaining ends 56b, 58b respectively movable toward and away from one another in response to pivoting movement of the arms with respect to one another. Preferably, the pair of pivotable arms 52b, 54b have a common pivot axis 60b. An actuator 62b is movable between first and second positions corresponding to a part-retaining position 64b illustrated on the right hand side of FIG. 7 and a part-releasing position 66b illustrated on the left hand side of FIG. 7 respectively. Means 68b is provided for connecting the actuator 62b to the corresponding pair of pivotable arms 52b, 54b for driving the arms in pivoting movement in response to movement of the actuator 62b between the first and second positions 64b, 66b. The connecting means 68b can include at least one pivotable link 70b, 72b connected between each actuator 62b and each pivotable arm 52b, 54b of the corresponding pair for moving the arms in pivoting movement with respect to one another in response to movement of the actuator 62b between the first and second position 64b, 66b. Biasing means 46b can be provided for urging the retaining means 26b toward one of the opened position and the closed position 36b, 38b. The biasing means 46b can include a spring 50b. The cam surface 42b can extend along all or one or more parts of the fixed path for operably engaging the cam follower 44b operably connected to the retaining means 26b and engagable with the cam surface 42b for moving the retaining means 26b between the open position and the closed position in response to the cam follower 44b moving along the cam surface 42b. The actuator 62b moves between the part-retaining position and part-releasing position 64b, 66b as the endless loop conveyor 16b moves either to the left or to the right as illustrated in FIG. 7 depending on the direction of travel.

Referring now to FIG. 8, another configuration of the retaining means 26c is illustrated. At least one cradle 14c is provided for receiving at least one workpiece or part 12c to be transported. An endless loop conveyor 16c extends along a fixed path and supports each cradle 14c for movement along the fixed path. Retaining means 26c is provided for retaining each workpiece or part 12c to be transported with respect to a corresponding cradle 14c while moving along at least a portion of the fixed path. The retaining means 26c can include at least one gripper, clamp or arm 52c, 54c, and preferably a pair of pivotable arms 52c, 54c associated with each cradle 14c. Each pair of pivotable arms 52c, 54c include part-retaining ends 56c, 58c movable toward and away from one another in response to pivoting movement of the arms with respect to one another. Preferably, the pair of pivotable arms 52c, 54c have a common pivot axis 60c. An actuator 62c is movable between first and second positions corresponding to a part-retaining position 64c and a part-releasing position 66c respectively. Means 68c for connecting the actuator to the corresponding pair of pivotable arms 52c, 54c is provided for driving the arms in pivoting movement in response to movement of the actuator between the first and second positions. The connecting means 68c can include at least one pivotable link 70c, 72c connected between each actuator 62c and each pivotable arm 52c, 54c of the corresponding pair for moving the arms in pivoting movement with respect to one another in response to movement of the actuator 62c between the first and second positions. Biasing means 46c can be provided for urging the retaining means 26c toward one of the part-retaining position 64c and part-releasing position 66c. The biasing means 46c can include a spring 50c. The actuator 62c is movable between first and second positions in response to engagement with a cam surface 42c. The cam surface 42c can extend along all, or one or more parts of the fixed path. The cam follower 44c is operably connected to the retaining means 26c and engagable with the cam surface 42c for moving the retaining means 26c between the opened position illustrated on the left hand side of FIG. 8 and the closed position illustrated on the right hand side of FIG. 8 in response to the cam follower 44c moving along the cam surface 42c. The actuator 62c moves between the part-retaining position and the part-releasing position in response to the endless loop conveyor 16c moving to the right or to the left depending on the direction of travel.

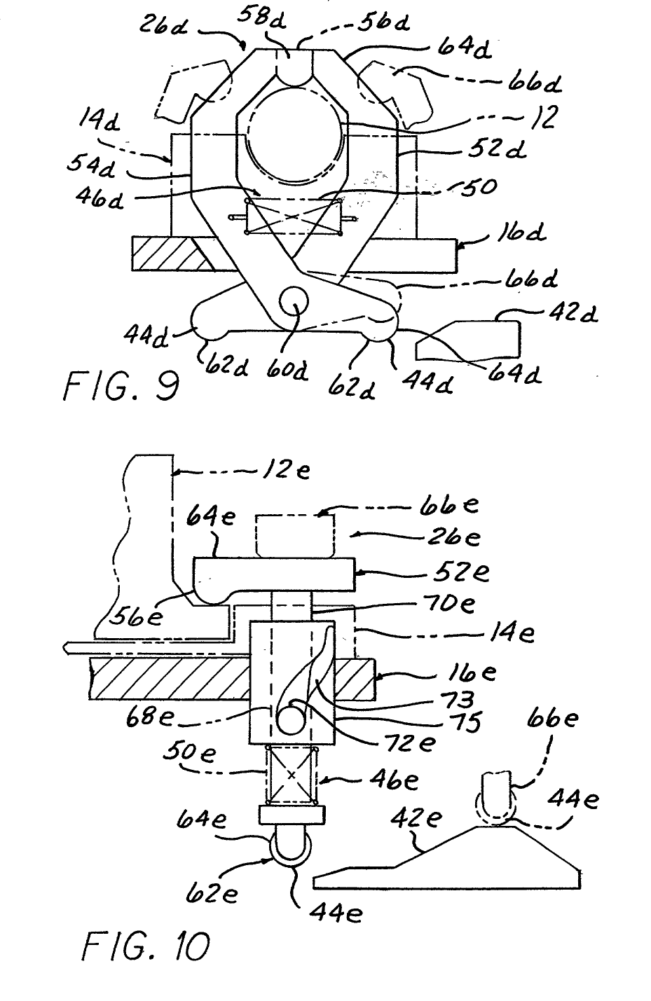

Referring now to FIG. 9, another configuration of the retaining means 26d is illustrated. At least one cradle 14d is provided for receiving at least one workpiece or part 12d to be transported. An endless loop conveyor 16d extends along a fixed path and supports each cradle 14c for movement along the fixed path. Retaining means 26d is provided for retaining each workpiece or part 12d to be transported with respect to a corresponding cradle 14d while moving along at least a portion of the fixed path. The retaining means 26d can include at least one gripper, clamp or arm 52d, 54d, and preferably a pair of pivotable arms 52d, 54d associated with each cradle 14d. Each pair of pivotable arms 52d, 54d include part-retaining ends 56d, 58d movable toward and away from one another in response to pivoting movement of the arms with respect to one another. Preferably, the pair of pivotable arms 52d, 54d have a common pivot axis 60d and close in an over center position. Actuators 62d are movable between first and second positions corresponding to a part-retaining position 64d and a part-releasing position 66d respectively. In this configuration, the actuators 62d are integral portions of the pivotable arms 52d, 54d on opposite sides of the common pivot axis 60d in order to define a scissors-type pincer gripper movement. Biasing means 46d can be provided for urging the retaining means 26d toward one of the part-retaining position 64d or part-releasing position 66d. The biasing means 46d can include a spring 50d. The actuators 62d are movable between first and second positions in response to engagement with a cam surface 42d. The cam surface 42d can extend along all, or one or more parts of the fixed path. The cam followers 44d are operably connected to the retaining means 26d and engagable with the cam surface 42d for moving the retaining means 26d between the opened position illustrated in phantom of FIG. 9 and the closed position illustrated in solid line in FIG. 9 in response to the cam follower 44d moving along the cam surface 42d. The actuator 62d moves between the part-retaining position and the part-releasing position in response to the endless loop conveyor 16d moving to the right or to the left depending on the direction of travel.

Referring now to FIG. 10, another configuration of the retaining means 26e is illustrated. At least one cradle 14e is provided for receiving at least one workpiece or part 12e to be transported. An endless loop conveyor 16e extends along a fixed path and supports each cradle 14e for movement along the fixed path. Retaining means 26e is provided for retaining each workpiece or part 12e to be transported with respect to a corresponding cradle 14e while moving along at least a portion of the fixed path. The retaining means 26e can include at least one gripper, clamp or arm 52e associated with each cradle 14e. Each arm 52e includes a part-retaining end 56e movable toward and away from the workpiece or part 12e to be retained. An actuator 62e is movable between first and second positions corresponding to a part-retaining position 64e and a part-releasing position 66e respectively. Means 68e connects the actuator 62e to the rotatable arm 52e for driving the arm 52e in rotational movement in response to movement of the actuator 62e between the first and second positions. The connecting means 68e can include a rotatable shaft 70e connected between the actuator 62e and the rotatable arm 52e. A cam follower pin 72e can be fixedly connected to the rotatable shaft 70e for rotational movement in response to the cam follower pin 72e operably engaging the cam surfaces of an arcuate slot 73 formed in stationary sleeve 75. The shaft 70e moves longitudinally and rotatably with respect to the sleeve 75 as the actuator 62e moves along the cam surface 42e between the part-retaining position 64e and the part-releasing position 66e. Biasing means 46e can be provided for urging the retaining means 26e toward one of the part-retaining position 64e or part-releasing position 66e. The biasing means 46e can include a spring 50e. The actuator 62e is movable between first and second positions in response to engagement with the cam surface 42e. The cam surface 42e can extend along all, or one or more parts of the fixed path. The cam follower 44e is operably connected to the retaining means 26e and engagable with the cam surface 42e for moving the retaining means 26e between the opened position illustrated in phantom in FIG. 10, and the closed position illustrated in solid line in FIG. 10, in response to the cam follower 44e moving along the cam surface 42e. The actuator 62e moves between the part-retaining position and the part-releasing position in response to the endless loop conveyor 16e moving to the right or to the left depending on the direction of travel. The shaft 70e and associated arm 52e can be configured to rotate through a predetermined angle about the center line of the shaft 70e in either a clockwise direction or a counter clockwise direction between the part-retaining position 64e and the part-releasing position 66e as desired for the particular application. The retaining means 26e can be placed on the pallet or cradle 14e in any desired configuration in order to suit the particular part configuration to be held in place during transport.

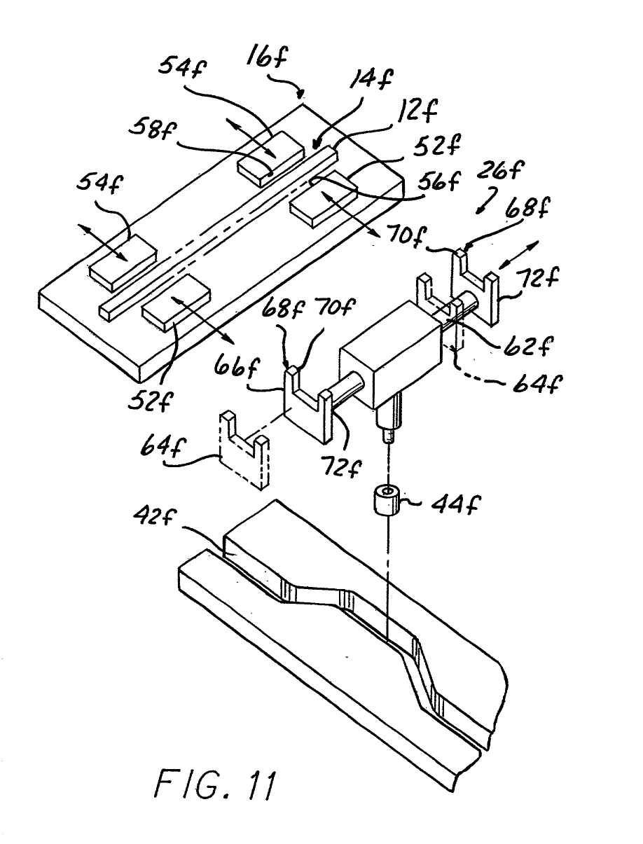

Referring now to FIG. 11, another configuration of the retaining means 26f is illustrated. At least one cradle 14f is provided for receiving at least one workpiece or part 12f to be transported. An endless loop conveyor 16f extends along a fixed path and supports each cradle 14f for movement along the fixed path. Retaining means 26f is provided for retaining each workpiece or part 12f to be transported with respect to a corresponding cradle 14f while moving along at least a portion of the fixed path. The retaining means 26f can include at least one reciprocal gripper, clamp or arm 52f, 54f, and preferably a pair of reciprocal arms 52f, 54f associated with each cradle 14f. Each pair of reciprocal arms 52f, 54f include part-retaining ends 56f, 58f movable toward and away from one another in response to reciprocal movement of the arms with respect to one another. An actuator 62f is movable between first and second positions corresponding to a part-retaining position 64f and a part-releasing position 66f respectively. Means 68f operably engages the actuator with respect to the corresponding pair of reciprocal arms 52f, 54f for driving the arms in reciprocal movement in response to reciprocal movement of the actuator 62f between the first and second positions. The connecting means 68f can include at least one drive member 70f, 72f connected to the actuator 62f for operable engagement with an angled wedge surface (not shown) on each of the corresponding pair of reciprocal arms 52f, 54f for moving the arms in reciprocal movement with respect to one another in response to movement of the actuator 62f between the first and second positions. Biasing means (not shown) can be provided for urging the pair of reciprocal arms 52f, 54f toward one of the part-retaining position 64f or part-releasing position 66f. The biasing means can include a spring. The actuator 62f is movable between the first and second positions in response to engagement with a cam surface 42f. The cam surface 42f can extend along all, or one or more parts of the fixed path. A cam follower 44f is fixedly connected to the actuator 62f and engagable with the cam surface 42f for moving the retaining means 26f between the opened position and the closed position in response to the cam follower 44f moving along the cam surface 42f. The actuator 62f moves between the part-retaining position and the part-releasing position in response to the endless loop conveyor 16f moving along the direction of travel.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for transporting parts comprising:
at least one cradle for receiving at least one part to be transported;
an endless loop conveyor extending around first and second rollers disposed at first and second ends, the endless loop conveyor supporting each cradle for movement along a fixed path; and
means for retaining each part to be transported with respect to a corresponding cradle while moving along at least a portion of the fixed path.

2. The apparatus of claim 1 further comprising:
the endless loop conveyor for moving each cradle in at least one direction of travel.

3. The apparatus of claim 1 further comprising:
the endless loop conveyor for moving each cradle between the first end and the second end in an upright orientation along one portion of the endless loop conveyor and in an inverted orientation along another portion of the endless loop conveyor.

4. The apparatus of claim 1 further comprising:
the retaining means moveable between a closed position for retaining each part to be transported with respect to the corresponding cradle and an opened position allowing removal of each part to be transported from the cradle.

5. The apparatus of claim 4 further comprising:
means for actuating the retaining means between the opened position and the closed position.

6. The apparatus of claim 5 wherein the actuating means further comprises:
a cam surface extending along at least a portion of the fixed path; and
a cam follower operably connected to the retaining means and engagable with the cam surface for moving the retaining means between the opened position and the closed position in response to the cam follower moving along the cam surface.

7. The apparatus of claim 5 further comprising:
biasing means for urging the retaining means toward one of the opened position and the closed position defined as a biased position.

8. The apparatus of claim 7 wherein the actuating means further comprises:
a cam surface extending along at least a portion of the fixed path; and
a cam follower operably connected to the retaining means and engagable with the cam surface for moving the retaining means to an opposite position from the biased position against the urging of the biasing means in response to the cam follower moving along the cam surface.

9. The apparatus of claim 1 further comprising:
each cradle including at least two spaced stanchions engagable with spaced longitudinal portions of the part to be transported; and
the retaining means positioned between the at least two spaced stanchions of each cradle.

10. The apparatus of claim 1 wherein the retaining means further comprises:
at least one pivotable arm associated with each cradle, each pivotable arm having a part-retaining end moveable toward and away from the corresponding cradle in response to pivoting movement of the arm.

11. The apparatus of claim 10 wherein the at least one pivotable arm further comprises a pair of pivotable arms having a common pivot axis.

12. The apparatus of claim 10 further comprising:
an actuator moveable between first and second positions corresponding to a part-retaining position and a part-releasing position; and
means for connecting the actuator to the corresponding pivotable arm for driving the arm in pivoting movement in response to movement of the actuator between the first and second positions.

13. The apparatus of claim 12 wherein the connecting means further comprises:
a cam surface formed in each pivotable arm; and
a cam follower connected to the actuator and engagable with the cam surface of each corresponding pivotable arm for moving the arm in pivoting movement in response to movement of the actuator between the first and second positions.

14. The apparatus of claim 12 wherein the connecting means further comprises:
at least one moveable link connected between each actuator and each arm for moving the arm in response to movement of the actuator between the first and second positions.

15. The apparatus of claim 12 further comprising:
a cam surface extending along at least a portion of the fixed path; and
a cam follower connected to the actuator and engagable with the cam surface for moving the actuator between the first and second positions in response to the cam follower moving along the cam surface.

16. An apparatus for transporting workpieces comprising:
at least one cradle for receiving at least one workpiece to be transported;
an endless loop conveyor extending around first and second rollers disposed at first and second ends, the endless loop conveyor supporting each cradle for movement along a fixed path;
means for retaining each workpiece to be transported with respect to a corresponding cradle while moving along at least a portion of the fixed path, the retaining means moveable between a closed position for retaining each workpiece to be transported with respect to the corresponding cradle and an opened position allowing removal of each workpiece to be transported from the cradle; and
means for actuating the retaining means between the opened position and the closed position, the actuating means including a cam surface extending along at least a portion of the fixed path, and a cam follower operably connected to the retaining means and engagable with the cam surface for moving the retaining means between the opened position and the closed position in response to the cam follower moving along the cam surface.

17. The apparatus of claim 16 further comprising:
the endless loop conveyor for moving each cradle in at least one direction of travel.

18. The apparatus of claim 16 further comprising:
the endless loop conveyor for moving each cradle between the first end and the second end in an upright orientation along one portion of the endless loop conveyor and in an inverted orientation along another portion of the endless loop conveyor.

19. The apparatus of claim 16 further comprising:
biasing means for urging the retaining means toward one of the opened position and the closed position defined as a biased position.

20. The apparatus of claim 16 further comprising:
each cradle including at least two spaced stanchions engagable with spaced longitudinal portions of the workpiece to be transported; and
the retaining means positioned between the at least two spaced stanchions of each cradle.

21. The apparatus of claim 16 wherein the retaining means further comprises:
at least one pivotable arm associated with each cradle, each pivotable arm having a part-retaining end moveable toward and away from the corresponding cradle in response to pivoting movement of the arm.

22. The apparatus of claim 21 wherein the at least one pivotable arm further comprises a pair of pivotable arms having a common pivot axis.

23. The apparatus of claim 21 further comprising:
an actuator moveable between first and second positions corresponding to a part-retaining position and a part-releasing position; and
means for connecting the actuator to the corresponding pivotable arm for driving the arm in pivoting movement in response to movement of the actuator between the first and second positions.

24. The apparatus of claim 23 wherein the connecting means further comprises:
a cam surface formed in each pivotable arm; and
a cam follower connected to the actuator and engagable with the cam surface of each corresponding pivotable arm for moving the arm in pivoting movement in response to movement of the actuator between the first and second positions.

25. The apparatus of claim 23 wherein the connecting means further comprises:
at least one pivotable link connected between each actuator and each pivotable arm for moving the arm in pivoting movement with respect to one another in response to movement of the actuator between the first and second positions.

26. The apparatus of claim 23 further comprising:
a cam surface extending along at least a portion of the fixed path; and
a cam follower connected to the actuator and engagable with the cam surface for moving the actuator between the first and second positions in response to the cam follower moving along the cam surface.
